(19) United States
(12) Patent Application Publication
(10) Pub. No.: US 2022/0056864 A1
(43) Pub. Date: Feb. 24, 2022

(54) FUEL INJECTION DEVICE

(71) Applicant: DENSO CORPORATION, Kariya-city (JP)

(72) Inventors: Fumiaki ARIKAWA, Nisshin-city (JP); Shuhei YAMAMOTO, Nisshin-city (JP); Makoto OTSUBO, Nisshin-city (JP); Takanobu AOCHI, Nisshin-city (JP); Yasuyuki HASEO, Nisshin-city (JP); Shingo KITANI, Kariya-city (JP); Hajime KATAOKA, Nisshin-city (JP); Satoshi HORITA, Kariya-city (JP)

(21) Appl. No.: 17/404,337

(22) Filed: Aug. 17, 2021

(30) Foreign Application Priority Data
Aug. 19, 2020 (JP) 2020-138626

(51) Int. Cl. F02D 41/20; F02D 41/30; F02D 41/06; F02D 41/22

(52) U.S. Cl. CPC F02D 41/20; F02D 41/30; F02D 2041/2068; F02D 41/22; F02D 2041/202; F02D 41/062

(57) ABSTRACT

A fuel injection device includes: an injector, an electronic control device, a communication circuit, and a power supply circuit. A memory is provided in the injector for storing fuel injection control data set for each injector. The electronic control device controls a fuel injection of the injector based on the control data. The communication circuit is installed for each injector, and enables the electronic control device to access the memory via wireless communication. The power supply circuit is installed for each injector, has a power source that supplies electric power to the communication circuit, and receives electric power to charge the power source from a drive line that connects the electronic control device and a drive unit of the injector.

### CROSS REFERENCE TO RELATED APPLICATION

The present application is based on and claims the benefit of priority of Japanese Patent Application No. 2020-138626, filed on Aug. 19, 2020, the disclosure of which is incorporated herein by reference.

### TECHNICAL FIELD

The present disclosure generally relates to a technique for controlling fuel injection from an injector.

### BACKGROUND ART

There is known a technique for permitting the start of a power source when an electronic control device authenticates a terminal device by wirelessly communicating with the terminal device.

### SUMMARY

It is an object of the present disclosure to provide a technique for supplying electric power for a communication circuit that wirelessly communicates with an electronic control device and makes the electronic control device accessible to a memory installed in an injector and storing control data for controlling fuel injection set for the injector.

A fuel injection device according to one aspect of the present disclosure includes: an injector, an electronic control device, a communication circuit, and a power supply circuit.

A memory is provided in the injector assembled to each cylinder of an engine, for storing fuel injection control data set for each injector.

The electronic control device controls an injection of the injector based on the control data stored in the memory.

The communication circuit is installed for each injector, and enables the electronic control device to access the memory via wireless communication.

The power supply circuit is installed for each injector, has a power source that supplies electric power to the communication circuit, and receives electric power to charge the power source from a drive line that connects the electronic control device and a drive unit of the injector.

According to such a configuration, even if the amount of charged electric power stored in the power source of the power supply circuit decreases, the electric power can be supplied and charged to the power source by supplying electric power from the drive line that supplies electric power to the drive unit of the injector, without replacing the power source. Therefore, the communication circuit can be supplied with electric power from the power source to continue wireless communication with the electronic control device.

### BRIEF DESCRIPTION OF THE DRAWINGS

FIG. 1 is a block diagram of a configuration of a fuel injection device according to a first embodiment;

FIG. 2 is a flowchart of a data writing process at the time of shipment of an injector;

FIG. 3 is a flowchart of an injector determination process when an engine is started;

FIG. 4 is a characteristic diagram of a relationship between a drive pulse width and a drive frequency during charging;

FIG. 5 is a characteristic diagram of a charging state showing a difference depending on a charging frequency and a charging pulse width;

FIG. 6 is a flowchart of an injector determination process at the time of starting the engine according to a second embodiment;

FIG. 7 is a pulse pattern for determining an injector;

FIG. 8 is another pulse pattern for determining an injector;

FIG. 9 is a schematic view of a power supply circuit of the injector according to a third embodiment; and

FIG. 10 is a time chart of a relationship between an ECU output signal and an induced electromotive force.

### DETAILED DESCRIPTION

Hereinafter, embodiments of the present disclosure are described with reference to the drawings.

### 1. First Embodiment

(1-1. Configuration)

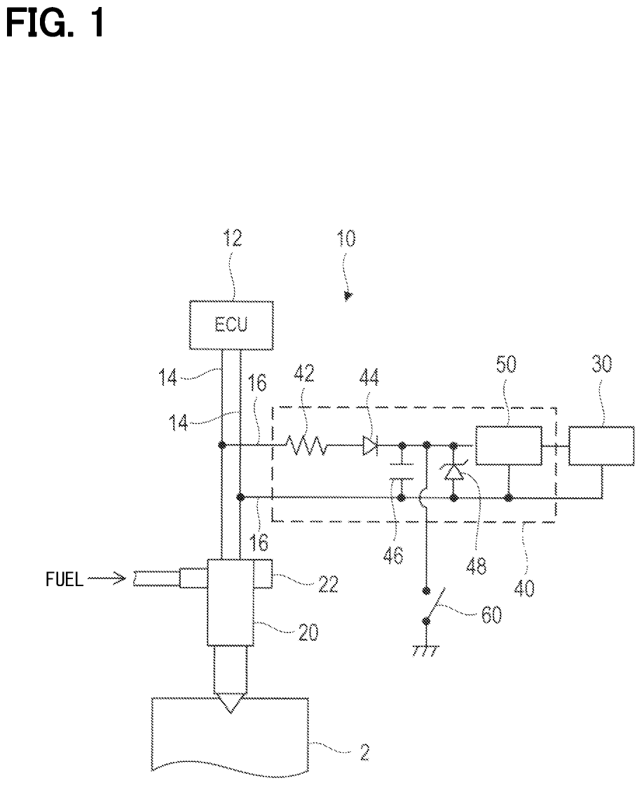

A fuel injection device 10 shown in FIG. 1 includes an electronic control device 12, an injector 20, a communication circuit 30, a power supply circuit 40, and a switch 60. Hereinafter, the electronic control device may also be referred to as an ECU (Electronic Control Unit). The communication circuit 30, the power supply circuit 40, and the switch 60 are installed in a connector of the injector 20 that connects a drive line 14 and the injector 20, which is described later.

The ECU 12 and the injector 20 are connected by the drive line 14. The ECU 12 supplies electric power to a drive unit of the injector 20 by a drive signal output to the drive line 14. The injector 20 is, for example, an injector for a diesel engine. In the injector 20, a control valve of the drive unit opens and closes a fuel pressure chamber on an opposite side of a nozzle needle injection hole to control a fuel pressure in the fuel pressure chamber, so that the nozzle needle reciprocates to inject fuel by opening and closing the injection hole.

The injector 20 is attached to each cylinder of the engine 2. The ECU 12 controls an injection amount and an injection timing of the injector 20 by a drive signal output to the drive line 14.

In response to the drive signal that instructs the same injection amount and the same injection timing, each injector 20 may inject a different injection amount and/or at a different injection timing due to a manufacturing error or the like. Therefore, each injector 20 is provided with a memory 22 that stores control data for correcting the drive signal and injecting fuel from the injector 20 according to a target injection amount and a target injection timing. Control data specific to each of the injectors 20 is stored in the memory 22.

The ECU 12 communicates with the communication circuit 30 by wireless communication, and reads out the control data stored in the memory 22 via the drive line 14, a connection line 16 described later, and the power supply circuit 40. The ECU 12 corrects the drive signal based on the control data read out from the memory 22, and controls the injection amount and the injection timing of the injector 20. Electric power is supplied to the communication circuit 30 from a capacitor 46 of the power supply circuit 40.

The power supply circuit 40 includes a resistor 42, a diode 44, the capacitor 46, a Zener diode 48, and a regulator 50. The power supply circuit 40 is connected to the drive line 14 by the connection line 16 branched from the drive line 14.

The diode 44 prevents backflow of electric current from the power supply circuit 40 to the drive line 14. The capacitor 46 is supplied with electric power required for charging from the ECU 12 via the drive line 14 and the connection line 16, and supplies electric power to the communication circuit 30. The Zener diode 48 steps down a voltage applied to the regulator 50 from the drive line 14 to prevent an application of a high voltage from the drive line 14 to the regulator 50. The regulator 50 adjusts the voltage applied to the communication circuit 30 to a constant voltage.

When the switch 60 is turned ON, the electric charge stored in the capacitor 46 flows to the ground, and the capacitor 46 is discharged.

(1-2. Processing)

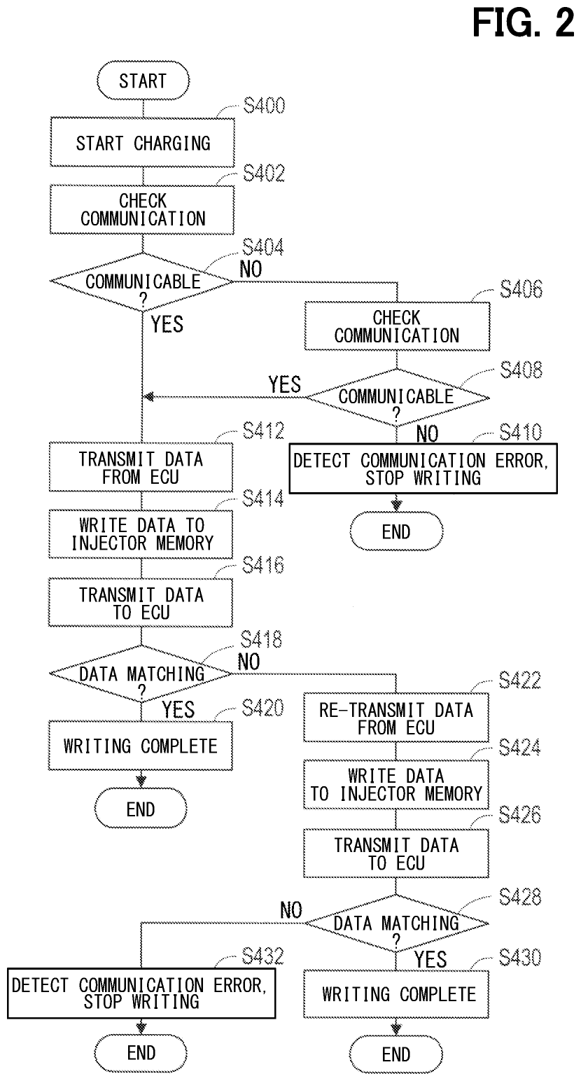

(1) FIG. 2 shows a memory initialization process at a factory. The ECU 12 writes control data to the memory 22 of the injector 20 at the factory when the injector 20 is shipped. This process is described with reference to a flowchart of FIG. 2. The ECU 12 performs the data writing process described below for each of the injectors 20 of all cylinders.

In S400, the ECU 12 starts charging the capacitor 46 via the drive line 14 and the connection line 16 in order to start wireless communication with the communication circuit 30. In S402, the ECU 12 checks whether or not it can communicate with the communication circuit 30 by pairing. If the determination in S404 is Yes based on the check result by S402, that is, when communication with the communication circuit 30 is possible, the process shifts to S412.

If the determination in S404 is No based on the check result by S402, that is, when communication with the communication circuit 30 is not possible, the ECU 12 again checks in S406 whether or not it can communicate with the communication circuit 30 by pairing. If the determination in S408 is Yes based on the check result by S406, that is, when communication with the communication circuit 30 is possible, the process shifts to S412.

If the determination in S408 is No based on the check result by S406, that is, when communication with the communication circuit 30 is not possible, the ECU 12 detects a communication error in S410 and stops writing data to the memory 22 via the communication circuit 30.

In S412, the ECU 12 transmits (i) the control data for correcting the injection amount and the injection timing of the injector 20 of the corresponding cylinder, and (ii) a product number and the like which are identification information specific to the injector 20 for identifying the injector 20, to the memory 22 to the communication circuit 30 as write data. Hereinafter, the identification information may also be referred to as an ID.

In S414, the write data transmitted from the ECU 12 to the communication circuit 30 is written to the memory 22. When the writing of the data to the memory 22 is complete, the communication circuit 30 in S416 transmits the identification information and the control data written in the memory 22 to the ECU 12 as injector information for identifying an injector 20.

In S418, the ECU 12 determines whether or not the data transmitted to the communication circuit 30 and the data transmitted from the communication circuit 30 match or not. When the determination in S418 is Yes, that is, when the data transmitted to the communication circuit 30 and the data transmitted from the communication circuit 30 match, the ECU 12 determines in S420 that the writing to the memory 22 is complete normally, and ends the process.

When the determination in S418 is No, that is, when the data transmitted to the communication circuit 30 and the data transmitted from the communication circuit 30 do not match, the ECU 12 re-transmits in S422 the control data to the communication circuit 30 for correcting the injection amount and the injection timing of the injector 20 of the corresponding cylinder.

In S424, the communication circuit 30 writes the data transmitted from the ECU 12 to the memory 22. When the writing of the data to the memory 22 is complete, the communication circuit 30 transmits the data written to the memory 22 back to the ECU 12 in S426.

In S428, the ECU 12 determines whether or not the data transmitted to the communication circuit 30 and the data transmitted from the communication circuit 30 match or not. When the determination in S428 is Yes, that is, when the data transmitted to the communication circuit 30 and the data transmitted from the communication circuit 30 match, the ECU 12 determines in S430 that the writing to the memory 22 is complete normally, and ends the process.

When the determination in S428 is No, that is, when the data transmitted to the communication circuit 30 and the data transmitted from the communication circuit 30 do not match, the ECU 12 detects a communication error in S432 and stops data writing to the memory 22 via the communication circuit 30.

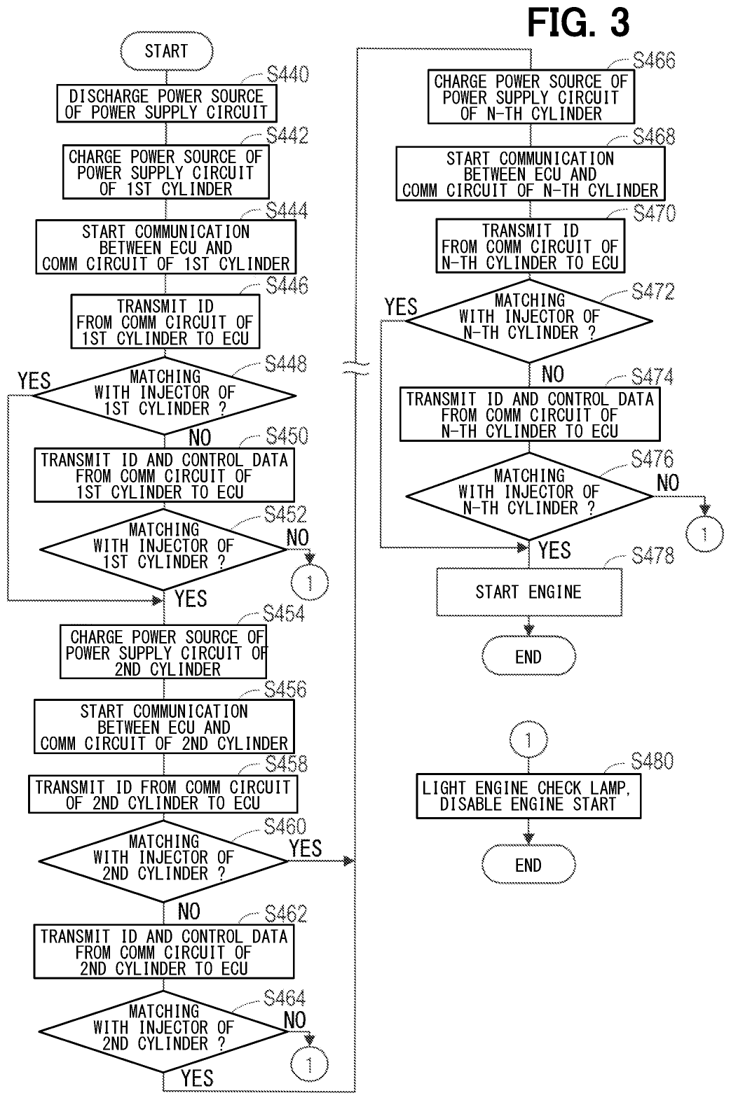

(2) FIG. 3 shows an injector determination process. The injector determination process determines whether or not an authentic injector 20 is installed in each cylinder of the engine, and is described with reference to a flowchart of FIG. 3. The flowcharted process of FIG. 3 is performed at a pre-communication timing, i.e., for example, when the ECU 12 determines that the engine is about to start by detecting an unlocking of the door of the vehicle, before the communication circuit of each injector 20 and the ECU 12 communicate with each other.

In S440, the ECU 12 discharges the capacitors 46 of the power supply circuits 40 of all cylinders, for example, by turning ON the switch 60 of each cylinder. As a result, communication between the ECU 12 and the communication circuits 30 of all cylinders becomes impossible. When the switch 60 is not installed, for example, the ECU 12 may consume electric power of the capacitor 46 and discharge the capacitor 46 by performing a temporal communication with the communication circuit 30.

In S442, the ECU 12 outputs a pulse signal to the drive line 14 to a first cylinder among N distinct cylinders, and charges the capacitor 46 of the power supply circuit 40 of the first cylinder. As a result, the ECU 12 enables communication with the communication circuit 30 of the first cylinder.

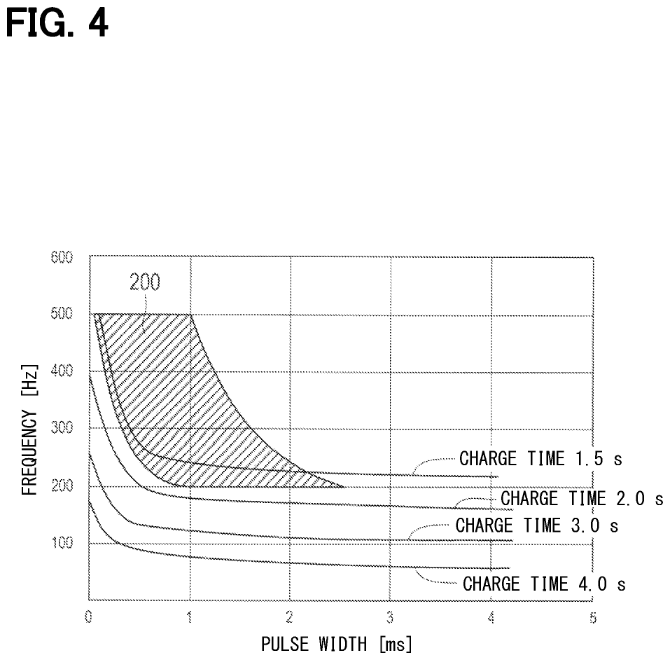

FIG. 4 shows a relationship between a pulse width and a frequency of the pulse signal for charging the capacitor 46 via the drive line 14 and the connection line 16. By charging the capacitor 46 within a range 200 of the pulse signal frequency of 200 Hz to 500 Hz and the pulse width of 0.1 ms to 2.5 ms, the communication circuit 30 is drivable and electric power required for communication with the ECU 12 is suppliable to the capacitor 46. Note that, when the frequency is 200 Hz, the pulse width is preferably 0.9 ms to 2.5 ms, and when the frequency is 500 Hz, the pulse width is preferably 0.1 ms to 1.0 ms.

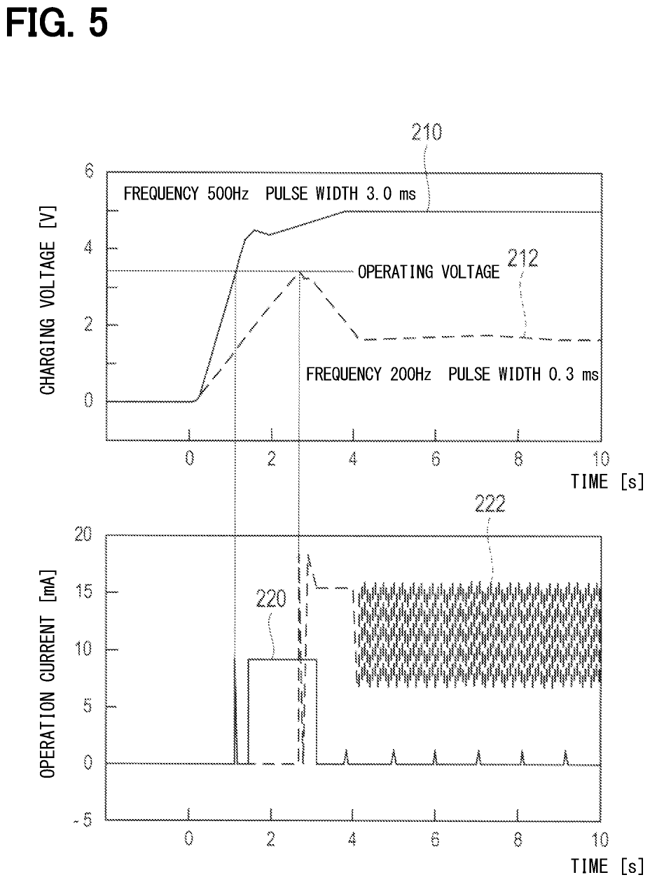

FIG. 5 shows that using a pulse signal 210 having a frequency of 500 Hz and a pulse width of 0.3 ms, even after a charging voltage 210 of the capacitor 46 reaches an operating voltage of the communication circuit 30, and the communication circuit 30 communicates with the ECU 12 for starting pairing, the charging voltage 210 still rises.

In such manner, the capacitor 46 stores electric power larger than the electric power consumed by the communication circuit 30 for communication, including the electric power consumed by pairing at the start of communication. Thus, a stable operating current 220 is supplied from the capacitor 46 to the communication circuit 30, and the communication circuit 30 can normally communicate with the ECU 12.

In FIG. 5, when the capacitor 46 is normally charged, the communication circuit 30 communicates with the ECU 12 at predetermined time intervals of about 1 s. On the other hand, in case of using a pulse signal 212 having a frequency of 200 Hz and a pulse width of 0.3 ms, the charging voltage 212 of the capacitor 46 reaches the operating voltage of the communication circuit 30, and the communication circuit 30 communicates with the ECU 12 to start pairing. Even so, the amount of charge charged to the capacitor 46 by the pulse signal 212 is insufficient.

Therefore, the electric power for the communication circuit 30 to complete pairing with the ECU 12 cannot be supplied from the capacitor 46 to the communication circuit 30, thereby the operating current 222 supplied from the capacitor 46 to the communication circuit 30 becomes unstable. Therefore, the communication circuit 30 cannot normally communicate with the ECU 12.

Note that, if the frequency of the pulse signal is 500 Hz and the pulse width is within a range of 0.1 ms to 0.2 ms, the capacitor 46 can be charged without operating the control valve of the drive unit of the injector 20 described above and without injecting fuel from the injector 20.

When a pulse signal having an appropriate frequency and appropriate pulse width is supplied from the ECU 12 to the drive line 14 and the capacitor 46 is charged, in S444, the ECU 12 starts communication with the communication circuit 30 of the injector 20 of the first cylinder by pairing.

In S446, the communication circuit 30 of the first cylinder transmits the ID of the injector 20 to the ECU 12 as the injector information for identifying the injector 20 of the first cylinder. In S448, the ECU 12 determines whether or not the ID of the injector 20 of the first cylinder stored in the ECU 12 and the ID transmitted from the injector 20 of the first cylinder match. If the determination in S448 is Yes, that is, if the ID of the injector 20 of the first cylinder stored in the ECU 12 matches the ID transmitted from the communication circuit 30 of the first cylinder, the process shifts to S454.

If the determination in S448 is No, that is, if the ID of the injector 20 of the first cylinder stored in the ECU 12 does not match the ID transmitted from the communication circuit 30 of the first cylinder, the communication circuit 30 transmits in S450 the ID and control data of the first cylinder stored in the memory 22 of the injector 20 of the first cylinder to the ECU 12 as the injector information for identifying the injector 20 of the first cylinder.

In S452, the ECU 12 determines whether or not the ID and control data of the injector 20 of the first cylinder stored in the ECU 12 match the ID and control data transmitted from the injector 20 of the first cylinder.

When the determination in S452 is No, that is, when the ID and control data of the injector 20 of the first cylinder stored in the ECU 12 do not match the ID and control data transmitted from the injector 20 of the first cylinder, the process shifts to S480.

When the determination in S452 is Yes, that is, when the ID and control data of the injector 20 of the first cylinder stored in the ECU 12 match the ID and control data transmitted from the injector 20 of the first cylinder, the ECU 12 determines that an authentic injector 20 is assembled in the first cylinder, and shifts the process to S454.

In the processing of S454 to S476, the ECU 12 performs the same processing as in S442 to S452 for the remaining cylinders. When, for all cylinders, (a) the ID of the corresponding injector 20 stored in the ECU 12 and the ID transmitted from the injector 20 of the corresponding cylinder match, or (b) the ID and control data of the injector 20 of the corresponding cylinder stored in the ECU 12 and the ID and control data transmitted from the injector 20 of the corresponding cylinder match, the ECU 12 permits the engine to start in S478. In one embodiment, not shown, the process for the second cylinder begins by discharging the power source (the capacitor) of the first cylinder (or of all cylinders). Similarly, the process for the third cylinder begins by discharging the power source of the second cylinder. This prevents undesired communications from previously used communication circuits.

When, for any of the cylinders, (a) the ID of the injector 20 of the corresponding cylinder stored in the ECU 12 and the ID transmitted from the injector 20 of the corresponding cylinder do not match, or (b) the ID and control data of the injector 20 of the corresponding cylinder stored in the ECU 12 and the ID and the control data transmitted from the injector 20 of the corresponding cylinder do not match, the ECU 12 lights a check lamp of the engine in S480 to notify abnormality, and disables start of the engine. Alternatively, some basic or emergency data may be used for operating the unknown fuel injector, while also sending error messages.

Note that the flowcharted process of FIG. 3 may be performed not only once before starting the engine but also at the start and thereafter of the engine at predetermined time intervals. In such case, in the flowchart of FIG. 3, only the ID such as the product number is first transmitted from the communication circuit 30 of each cylinder to the ECU 12 for the determination process of the injector 46. However, the first communication before starting the engine may transmit the ID (i.e., the product number and the like) and the control data stored in the memory 22 from the communication circuit 30 of each cylinder to the ECU 12 for the determination process for determining the injector 46.

Then, in the second and subsequent communications, as in the flowchart of FIG. 3, only the ID such as the product number is firstly transmitted from the injector 20 of each cylinder to the ECU 12 for the determination process of the injector 46.

(1-3. Effects)

The first embodiment described above achieves the following effects. (1a) Even if the amount of electric power stored in the capacitor 46 of the power supply circuit 40 decreases, electric power can be supplied to the communication circuit 30 from the capacitor 46, which is a power source, by charging the capacitor 46 without replacing the capacitor 46.

(1b) Since the capacitors 46 of the power supply circuits 40 of all cylinders are discharged before the engine is started, erroneous communication with the communication circuit 30 of the injector 20 whose cylinder determination is not performed, which is not the corresponding cylinder for which cylinder determination is performed. As a result, it is possible to prevent an erroneous determination process, in which an injector 20, which is not in a corresponding cylinder for which a cylinder determination is performed, undergoes a cylinder determination. Further, the previously used capacitor (or all capacitors) can be discharged before performing the matching check of the second or subsequent injectors.

(1c) As shown in the flowchart of FIG. 3, the communication circuit 30 of each cylinder transmits an ID such as a product number and the like to the ECU 12, and, if the transmitted ID and the stored ID match, the communication circuit 30 does not transmit control data to the ECU 12. Therefore, the communication load for performing the determination process of the injector 20 is reducible. As a result, the engine is quickly startable.

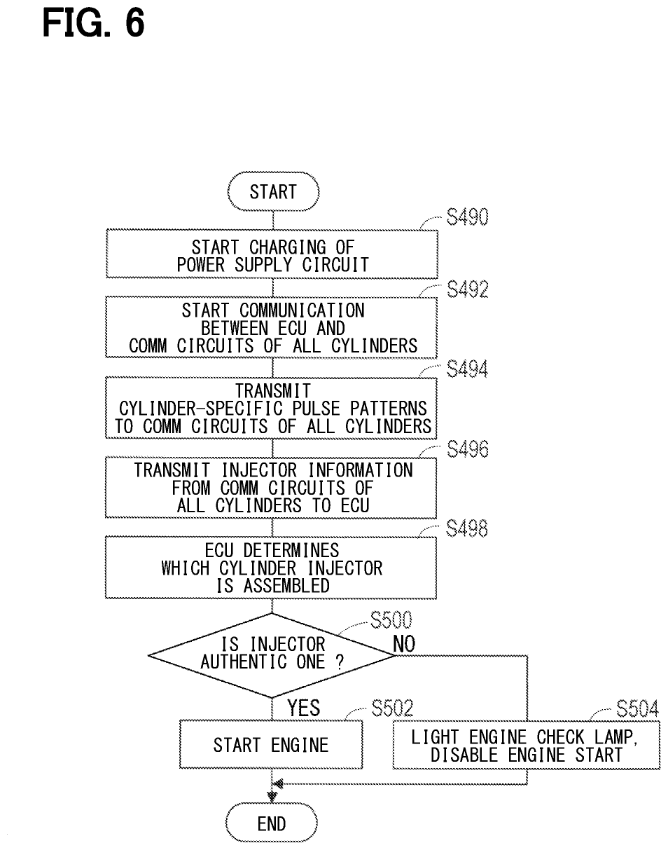

### 2. Second Embodiment, FIG. 6

(2-1. Difference from the First Embodiment) The fundamental configuration of the second embodiment is similar to that of the first embodiment. Therefore, the difference therebetween is described below. The same reference numerals as in the first embodiment denote the same components, and reference is made to the preceding description.

In the first embodiment described above, the ID of the injector 20 such as the product number is transmitted from the communication circuit 30 of the injector 20 to the ECU 12 in order from the first cylinder before the engine is started, and, based on the transmitted ID and the ID stored in the ECU 12, the ECU 12 determines whether or not the injector 20 of the corresponding cylinder is an injector normally assembled in the corresponding cylinder as an authentic one.

On the other hand, the second embodiment is different from the first embodiment in that a signal for determining a cylinder is transmitted from the ECU 12 to the injector 46. Note that the configuration of the fuel injection device of the second embodiment is substantially the same as that of the fuel injection device 10 of the first embodiment.

(2-2. Processing)

FIG. 6 shows the determination process of the injector 20 performed by the fuel injection device 10 of the second embodiment.

In S490, the ECU 12 starts charging the capacitor 46 of the power supply circuits 40 of all cylinders by a pulse signal having a predetermined frequency and pulse width. In S492, the ECU 12 starts communication with the communication circuits 30 of all cylinders after completing pairing with the communication circuits 30 of all cylinders.

In S494, the ECU 12 supplies (i.e., transmits to the communication circuit 30 of each cylinder) a pulse signal having a pulse pattern specific to the cylinder in order to determine to which of the cylinders an injector 20 is assembled.

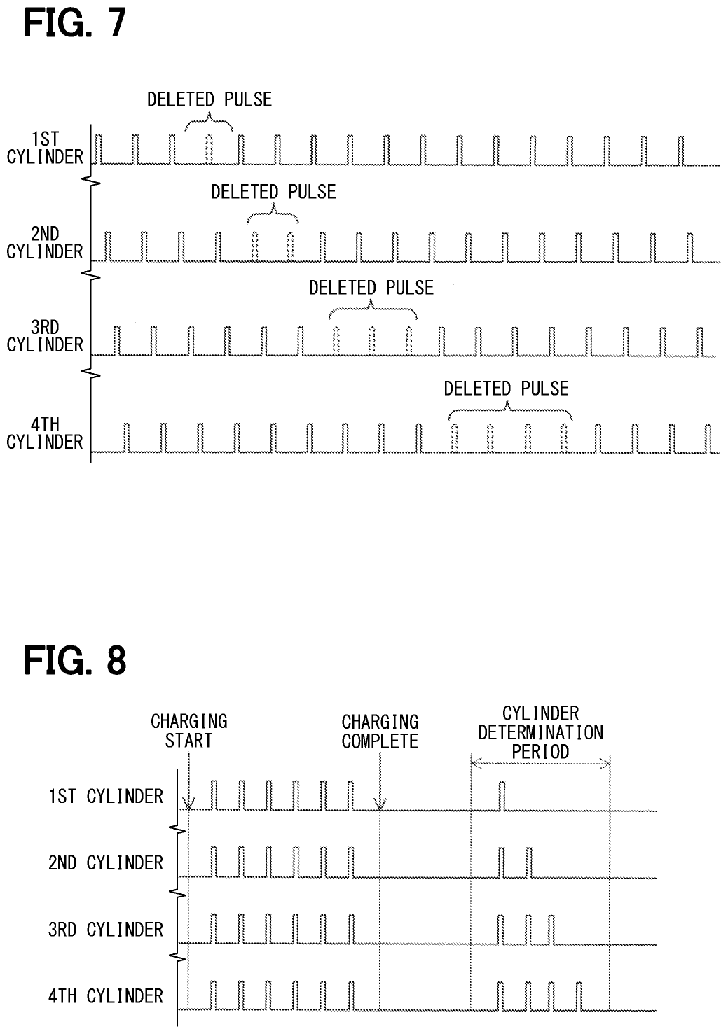

In FIG. 7, a pulse signal having a pulse pattern in which the same number of pulses as the cylinder number is deleted and reduced is output to the drive line 14 of each cylinder, while charging the capacitor 46. Alternatively, as shown in FIG. 8, when the charging of the capacitor 46 is complete, the same number of pulses as the cylinder number is output to the drive line 14 of each cylinder during a predetermined cylinder determination period.

The communication circuit 30 determines a cylinder to which the subject injector 20 is assembled based on the pulse pattern of the pulse signal supplied from the ECU 12, and sets it as cylinder information. In S496, the communication circuit 30 of each cylinder transmits the cylinder information and the ID such as the product number of the injector 20 stored in the memory 22 to the ECU 12 as the injector information.

In S498, the ECU 12 determines the injector 20 based on the injector information transmitted from the communication circuit 30 of each cylinder. In S500, the ECU 12 determines whether or not an authentic injector 20 is assembled to a corresponding cylinder represented by the cylinder information based on the cylinder information and the ID transmitted from the communication circuit 30 of each cylinder.

If the determination in S500 is Yes, that is, when an authentic injector 20 is assembled in the corresponding cylinder, the ECU 12 permits the engine to start in S502. When the determination in S500 is No, that is, when the authentic injector 20 is not assembled in the corresponding cylinder, the ECU 12 lights the check lamp of the engine in S504 to notify the abnormality, and disables the start of the engine.

[2-3. Effect] According to the second embodiment described above, the same effect as the effect (1a) of the first embodiment described above is achievable.

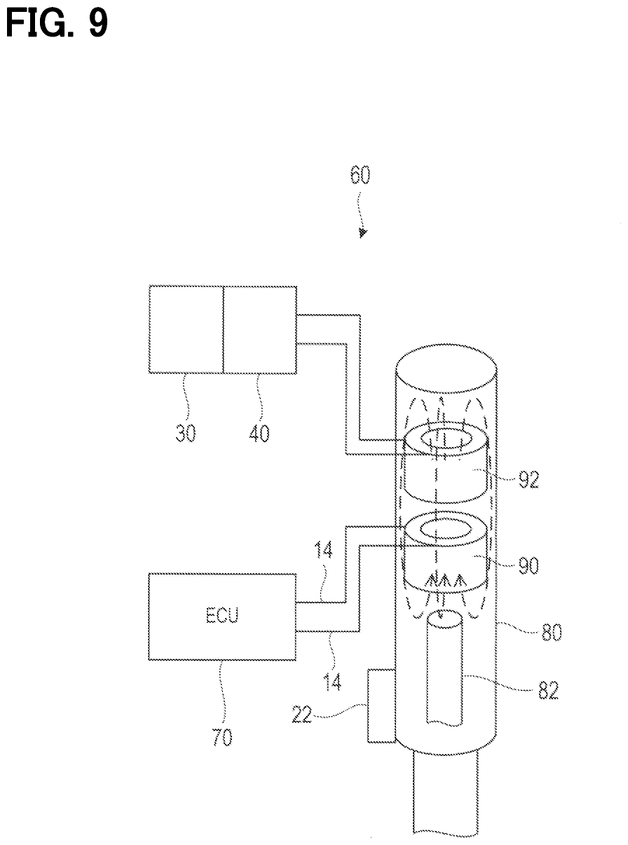

### Third Embodiment, FIG. 9

(3-1. Difference from First Embodiment)

Since the basic configuration of the third embodiment is the same as that of the first embodiment, the differences is described below. The same reference numerals as in the first embodiment denote the same components, and reference is made to the preceding description.

In the first embodiment described above, the capacitor 46 is charged by directly supplying electric power to the capacitor 46 from the connection line 16 branched from the drive line 14 that supplies electric power from the ECU 12 to the injector 20. On the other hand, the third embodiment is different from the first embodiment in that the capacitor 46 is charged by using an induced electromotive force (induction voltage) generated in a coil by the electric power supplied to the drive line 14.

(3-2. Configuration)

As shown in FIG. 9, a fuel injection device 60 of the third embodiment includes the communication circuit 30, the power supply circuit 40, an electronic control device 70, and an injector 80.

The injector 80 includes a needle 82 for opening and closing a fuel injection hole, a drive coil 90 for opening and closing the fuel control chamber to drive the needle 82, and a second coil 92 having the drive coil 90 as a first coil. In the present embodiment, the number of turns of the second coil 92 is larger than the number of turns of the drive coil 90.

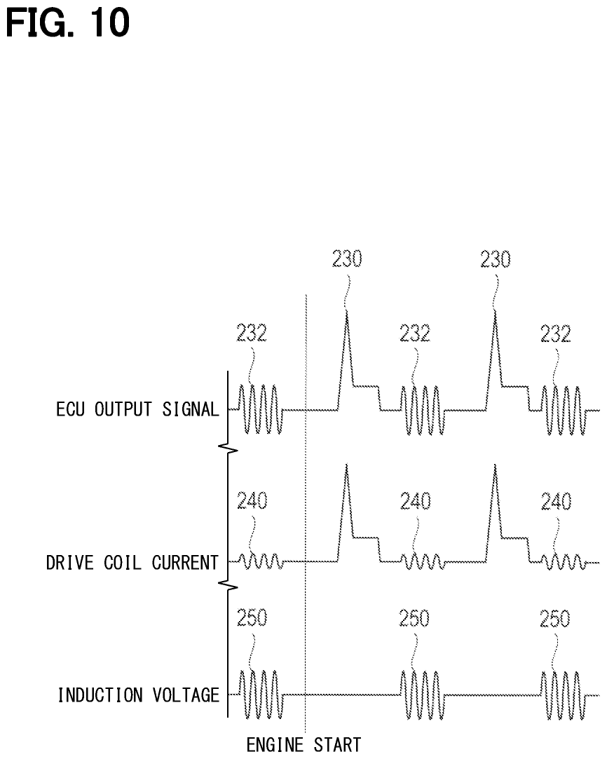

As shown in FIG. 10, when the ECU 70 determines that the engine is about to start based on, for example, an unlocking of a door on a driver's seat side, the ECU 70 outputs a high frequency signal 232 having a higher frequency than a normal drive signal 230 that opens and closes the fuel injection hole of the injector 80 to the drive line 14.

When the signal 232 having a higher frequency than the normal drive signal 230 is output from the drive line 14 to the drive coil 90 of the injector 80, it becomes difficult for an electric current to flow through the drive coil 90 due to the inductance of the drive coil 90. As a result, an electric current 240 flowing through the drive coil 90 becomes lower than a current value required for reciprocating a nozzle needle 82, thereby the injector 80 does not inject fuel.

On the other hand, the high frequency signal 232 supplied to the drive coil 90 generates a high frequency induced electromotive force 250 in the second coil 92, and electric power is supplied to the power supply circuit 40. The high frequency induced electromotive force 250 easily flows through the capacitor 46. Therefore, the induced electromotive force 250 generated in the second coil 92 applies a voltage required for charging the capacitor 46, and the capacitor 46 is charged.

By supplying the high frequency signal 232 to the drive coil 90 at positions between two drive signals 230 after the engine is started, the capacitor 46 is chargeable without reciprocally driving the nozzle needle 82 of the injector 80 even during engine operation.

(3-3. Effects)

According to the third embodiment described above, the following effects are achievable in addition to the effects of the first embodiment described above.

(3a) By adjusting the number of turns of the drive coil 90 and the second coil 92, the voltage of the induced electromotive force generated in the second coil 92 can be made higher than the electric power supplied from the drive line 14 to the drive coil 90. As a result, the capacitor 46 is chargeable in a short time.

(3b) When charging the capacitor 46, the high frequency signal 232 having a higher frequency than usual is supplied to the drive line 14, thereby the capacitor 46 is chargeable without operating the injector 20 before starting the engine and during engine operation.

### 4. Other Embodiments

Although embodiments of the present disclosure have been described above, the present disclosure is not limited to the above-described embodiments, and it is possible to implement various modifications.

(4a) In the above embodiments, the capacitor 46 is used as a power source for supplying electric power to the communication circuit 30, but the present disclosure is not limited to such a configuration. For example, a rechargeable storage battery may be used as a power source.

(4b) A plurality of functions possessed by one component in the above embodiments may be realized by a plurality of components, or one function possessed by one component may be realized by a plurality of components. In addition, multiple functions of multiple components may be realized by one component, or a single function realized by multiple components may be realized by one component. Moreover, part of the configuration of the above-described embodiments may be omitted. Further, at least part of the configuration of one or more of the above-described embodiments may be added to or replaced with the configuration of another embodiment described above.

(4c) In addition to the fuel injection device described above, the present disclosure can be realized in various forms such as a fuel injection system having the fuel injection device as a component.

What is claimed is:

1. A fuel injection device comprising:
an injector having a memory that stores fuel injection control data set for each injector installed in each cylinder of an engine;
an electronic control device configured to control fuel injection of the injector based on the control data stored in the memory;
a communication circuit installed for each injector, enabling the electronic control device to access the memory via wireless communication; and
a power supply circuit installed for each injector, having a power source that supplies electric power to the communication circuit, and receives electric power to charge the power source from a drive line that connects the electronic control device and a drive unit of the injector.

2. The fuel injection device of claim 1, wherein
the electronic control device supplies a pulse signal having a pulse width of 0.1 ms to 2.5 ms when a frequency is 200 Hz, or supplies a pulse signal having a pulse width of 0.1 ms to 1.0 ms when the frequency is 500 Hz, when the frequency is in a range of 200 Hz to 500 Hz and the pulse width is in a range of 0.1 ms to 2.5 ms.

3. The fuel injection device of claim 2, wherein
the electronic control device is configured to cause the communication circuit to determine the cylinder in which the communication circuit is installed by increasing or decreasing a number of pulses of the pulse signal of each cylinder.

4. The fuel injection device of claim 1, wherein
the power supply circuit is connected to the drive line by a connection line branched from the drive line.

5. The fuel injection device of claim 1, wherein
the drive unit includes a first coil connected to the drive line, and
the power supply circuit includes a second coil in which an induced electromotive force is generated by a drive current flowing through the first coil, for charging the power source of the power supply circuit by the induced electromotive force.

6. The fuel injection device of claim 5, wherein
the electronic control device is configured to supply a signal having a frequency higher than the frequency of the drive signal that controls fuel injection of the injector to the first coil from the drive line to generate the induced electromotive force.

7. The fuel injection device of claim 1, wherein
the electronic control device is configured to perform a determination process for determining whether or not an authentic injector is assembled to the cylinder based on injector information for identifying the injector received from the communication circuit.

8. The fuel injection device of claim 7, wherein
the electronic control device is configured to perform the determination process before starting the engine.

9. The fuel injection device of claim 8, wherein
a period before starting the engine is defined as a period from unlocking of a vehicle door to the start of the engine.

10. The fuel injection device of claim 8, wherein
the electronic control device is configured to perform the determination process,
permit the engine to start when the authentic injector is assembled in a corresponding cylinder, and
perform at least one of an abnormality notification and engine start prohibition when the authentic injector is not assembled in the corresponding cylinder.

11. The fuel injection device of claim 7, wherein
the electronic control device is configured to
receive injector-specific identification information specific to the injector as the injector information for identifying the injector from the communication circuit,
perform the determination process for determining whether the received injector information and the injector information stored in the electronic control device match,
when the injector information match, receive the identification information from the communication circuit of an other injector and perform the determination process, and
when the injector information do not match, receive from the communication circuit of a corresponding injector, the identification information and the control data as the injector information and perform the determination process.

12. The fuel injection device of claim 11, wherein
the electronic control device is configured to discharge the power sources of all the power supply circuits before receiving the injector information from each of the communication circuits.

13. A fuel injection device comprising:
a first communication system associated with a first fuel injector,
wherein the first fuel injector is associated with a first cylinder,
wherein the first fuel injector includes a first injector memory, and
wherein the first communication system includes:
(i) a first upper communication line configured for electrical connection to a first left drive line,
(ii) a first lower communication line configured for electrical connection to a first right drive line,
(iii) a first resistor including: first resistor left end, and a first resistor right end, wherein the first resistor left end is connected to the first upper communication line,
(iv) a first blocking diode including: a first blocking diode anode end, and a first blocking diode cathode end, wherein the first blocking diode anode end is connected to the first resistor right end,
(v) a first capacitor connecting the first blocking diode cathode end to the first lower communication line,
(vi) a first switch connecting the first blocking diode cathode end to a ground when switched ON,
(vii) a first Zener diode connecting the first blocking diode cathode end to the first lower communication line, and configured to discharge the first capacitor when a first capacitor voltage exceeds a first Zener voltage,
(viii) a first regulator connecting the first blocking diode cathode end to the first lower communication line, and
(ix) a first communication circuit connecting the first regulator to the first lower communication line.

14. The fuel injection device of claim 13, further comprising:
a second communication system associated with a second fuel injector,
wherein the second fuel injector is associated with a second cylinder,
wherein the second fuel injector includes a second injector memory, and
wherein the second communication system includes:
(i) a second upper communication line configured for electrical connection to a second left drive line,
(ii) a second lower communication line configured for electrical connection to a second right drive line,
(iii) a second resistor,
(iv) a second blocking diode,
(v) a second capacitor
(vi) a second switch,
(vii) a second Zener diode,
(viii) a second regulator, and
(ix) a second communication circuit.

15. The fuel injection device of claim 13, further comprising:
an electronic control unit including:
(i) a control unit processor, and
(ii) a computer-readable storage medium,

16. The fuel injection device of claim 14, wherein the fuel injection device is configured to perform an injector determination process comprising:
discharge the first capacitor and the second capacitor;
charge the first capacitor using a first charging signal from the first left drive line, wherein the first charging signal uses a first frequency and a first pulse width configured to charge the first capacitor and to NOT open the first fuel injector;
start communication between the first communication circuit and an electronic control unit (ECU);
transmit a first identification data (ID) from the first injector memory to the ECU; and
determine, by the ECU, whether the first ID from the first injector memory matches a stored first ID associated with the first fuel injector.

17. The fuel injection device of claim 16, wherein the injector determination process further comprises:
determine, by the ECU, that the first ID from the first injector memory matches the stored ID associated with the first fuel injector;
charge the second capacitor;
start communication between the second communication circuit and the ECU;
transmit a second ID from the second injector memory to the ECU; and
determine, by the ECU, whether the second ID from the second injector memory matches a stored second ID associated with the second fuel injector.

18. The fuel injection device of claim 16, wherein the injector determination process further comprises:
determine, by the ECU, that the first ID from the first injector memory does NOT match the stored ID associated with the first fuel injector; and
send an error message and disable an engine start function.

19. The fuel injection device of claim 13,
wherein the first fuel injector memory is configured to store:
(i) a first fuel injector identification, and
(ii) first fuel injector control data,
wherein the first fuel injector control data is associated with individual properties of the first fuel injector, and such the fuel injector control data is associated with a first corrected drive signal for the first fuel injector, and
wherein the first corrected drive signal is based at least partly on:
(i) a first target amount,
(ii) a first target timing,
(iii) the first fuel injector control data, and
(iv) a first uncorrected drive signal.
